(19) United States
(12) Patent Application Publication
(10) Pub. No.: US 2026/0209908 A1
(43) Pub. Date: Jul. 23, 2026

(54) MULTIPURPOSE HIGH-STRENGTH STEEL FOR AUTOMOBILES AND PREPARATION METHOD THEREFOR

(71) Applicant: ANGANG STEEL COMPANY LIMITED, Liaoning (CN)

(72) Inventors: Zhiping HU, Anshan (CN); Rendong LIU, Anshan (CN); Xingli GU, Anshan (CN); Jinyu GUO, Anshan (CN); Li LIN, Anshan (CN); Chunqing LIN, Anshan (CN)

(21) Appl. No.: 19/157,935

(22) PCT Filed: Jun. 8, 2023
(86) PCT No.: PCT/CN2023/099154

§ 371 Date: Aug. 19, 2025

(30) Foreign Application Priority Data
May 30, 2023 (CN) 202310625790.1

(51) Int. Cl. C22C 38/04; C21D 6/00; C21D 8/0221; C21D 8/0247; C21D 8/0278; C21D 9/46; C22C 38/00; C22C 38/02; C22C 38/06; C23C 2/06; C23C 2/28

(52) U.S. Cl. CPC C22C 38/04; C21D 6/005; C21D 8/0226; C21D 8/0236; C21D 8/0273; C21D 8/0278; C21D 9/46; C22C 38/002; C22C 38/02; C22C 38/06; C23C 2/06; C23C 2/28

(57) ABSTRACT

A multipurpose high-strength steel for automobiles includes the following chemical components in percentages by mass: 0.12-0.16% of C, 1.80-2.30% of Mn, 0.60-1.30% of Si, 0.015-0.5% of Al, 0.007-0.012% of P, 0.001-0.004% of S and the balance of Fe and inevitable impurities. a preparation method therefor includes the following steps: continuous casting, hot rolling, acid pickling, cold rolling, and continuous annealing and galvanizing. Steel plates having the same or similar components are used to cover various types and strengths of steel by means of different heat treatment processes. On the production end, the casting of waste steel from a mixed casting section is reduced, such that the rolling production efficiency is improved, and the management process is optimized; and on the application end, the welding difficulty can be reduced, and the use range of a material is widened.

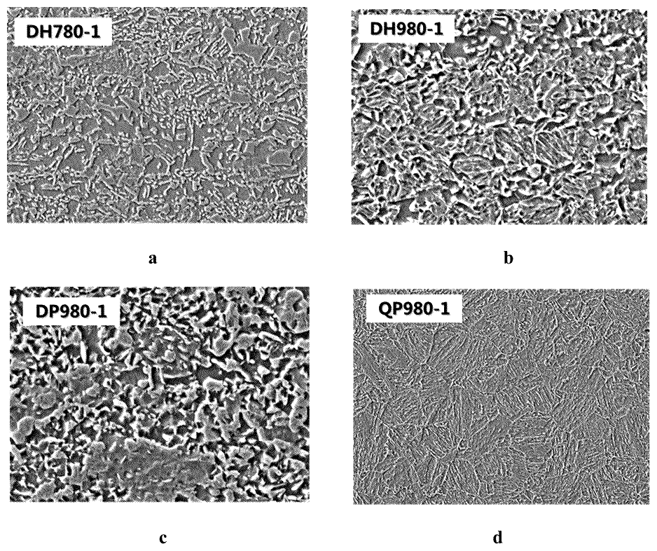

### TECHNICAL FIELD

The present invention belongs to the technical field of high-strength cold-rolled steel for automobiles, particularly to multipurpose high-strength steels for automobiles and a preparation method therefor.

### BACKGROUND ART

“Peak carbon dioxide emissions” and “carbon neutrality” are consensuses reached by global countries on the sustainable development of human beings in the future, and they are necessary conditions for the development of human science and technology as well as civilization. Main industries that emit CO₂ include cement, steel and automobiles. The automobile industry accounts for a relatively high proportion, of which the CO₂ emissions from the US automobile industry account for 28% of the total global CO₂ emissions, the EU account for 18%, and China account for 6%. Comprehensively considering the global carbon dioxide emissions, both the steel and automobile industries are high carbon emission industries. Moreover, the main carbon emission pathway of the automobile industry is concentrated in the stage of automobile steel production. Therefore, effective improvement measures to achieve the “dual carbon” goals for automobile steel are essential. Automobile lightweighting is currently the main focus of the automobile industry and automobile steel manufacturers. It is clear that by manufacturing high-strength steel for automobile steel to reduce the material consumption, safety can be ensured on the production side while effectively reducing steel output, and weight reduction and exhaust emission reduction can be achieved on the application side. However, from the current perspective of the development of high-strength steel, the market consumption of high-strength steel for automobiles is still limited, and it needs to meet the personalized customization of users, resulting in a wide variety of types of the high-strength steel for automobiles. Taking QP980 steel as an example, its products cover high-plasticity QP980 products, high-hole expansion ratio QP980 products, high-plasticity QP980 galvanized products, high-hole expansion ratio QP980 galvanized products, and so on. A steel grade involves several, or even more than ten, varieties of steel. Different grades of products correspond to respective chemical composition, which significantly increase production costs and, more importantly, carbon emissions during the production process. Therefore, addressing the issue of wide variety of automobile high-strength steels is crucial for reducing costs and carbon emissions for steel enterprises.

Chinese patent application CN111979488A discloses a 780 MPa-grade alloyed hot-dip galvanized DH steel and a preparation method therefor. This steel includes chemical components in percentage by weight of 0.11-0.17% of C, 1.4-2.4% of Mn, 0.15-0.60% of Si, 0.02-1.0% of Al, 0.20-0.70% of Mo, less than or equal to 0.03% of P, less than or equal to 0.03% of S, less than or equal to 0.005% of B, less than or equal to 0.05% of V, less than or equal to 0.05% of Ti, and the balance of Fe and other inevitable impurities. This preparation method includes smelting, hot rolling, acid pickling, cold rolling, and continuous annealing and galvanizing, which obtain a DH galvanized steel sheet having a tensile strength of 780-880 MPa and an elongation of 20-25%. The conception of this method is to introduce retained austenite to improve the plasticity of the steel plates through an alloy design with a high proportion C and Mn within the 780 MPa grade range.

Chinese patent application CN110983198A discloses an alloyed hot-dip galvanized dual-phase steel and a preparation method therefor. This steel has alloy components of 0.10-0.15% of C, 0.2-0.5% of Si, 2.5-2.9% of Mn, 0.02-0.05% of Al, 0.015-0.03% of Ti, 0.015-0.03% of Nb, 0.4-0.6% of Cr, 0.1-0.3% of Mo, less than or equal to 0.01% of P, less than or equal to 0.01% of S, and the balance of Fe and other inevitable impurities. This preparation method includes smelting, hot rolling, acid pickling, cold rolling, and continuous annealing and galvanizing, which obtain a steel plate having a tensile strength of over 1180 MPa.

Chinese patent application CN111118397A discloses a 980 MPa quenching and partitioning steel and a preparation method therefor. This steel has alloy components of 0.20-0.25% of C, 1.4-1.8% of Si, 1.8-2.2% of Mn, 0-0.10% of V, 0-0.050% of Nb, 0-0.050% of Ti, less than or equal to 0.010% of P, less than or equal to 0.012% of S, less than or equal to 0.060% of Al, and the balance of Fe and other inevitable impurities. This method can prepare a cold-rolled annealed steel sheet having a high strength of 980-1150 MPa and an elongation of 20-25%.

The abovementioned dual-phase steels with high formability (DH steel), dual-phase (DP) steel and quenching and partitioning (QP) steel have different alloy composition design systems and exhibit different combinations of strength and plasticity. However, there is still a gap in achieving a multipurpose high-strength steel design that can meet various mechanical properties and satisfy application performance criteria for multiple uses with one steel type.

### SUMMARY

In order to solve the aforementioned technical problems, the present invention provides multipurpose high-strength steels for automobiles and a preparation method therefor. With the same alloy composition system, multipurpose high-strength steels can be prepared simply by changing the subsequent processes.

To achieve the abovementioned objectives, the technical solution of the present invention is as follows:

An aspect of the present invention is to provide a multipurpose high-strength steel for automobiles, including the following chemical components in percentage by mass:

0.12-0.16% of C, 1.80-2.30% of Mn, 0.60-1.30% of Si, 0.015-0.5% of Al, 0.007-0.012% of P, 0.001-0.004% of S, and a balance of Fe and inevitable impurities.

In the above technical solution, the chemical components of the steel further includes at least one of Ni, Cr, Mo, Nb and Ti, with their contents in percentage by mass: 0.10-0.30% of Ni, 0.10-0.30% of Cr, 0.05-0.30% of Mo, 0.015-0.025% of Nb, and 0.01-0.025% of Ti, of which a total mass of Mn, Ni, Cr and Mo is less than or equal to 2.50%.

The selection principles of chemical components and reasons for the content design of the steel in the present invention are as follows:

C: C is a common strengthening element in steel. As an interstitial solid solution atom, C atoms are dissolved in the matrix and enhance the strength of solid solution by inducing lattice distortion. The role of C in the multipurpose high-strength steel for automobiles of the present invention includes an effect in DH steel and QP steel in ensuring the stability of retained austenite in DH steel and QP steel, and an effect in DP steel in improving the hardenability in the critical zone to ensure the transformation amount of martensite. However, the C content in the present invention is generally in a low-carbon range. Taking into account the performance of resistance spot welding and problems of hot-rolled edge cracks and cold-rolled edge cracks, the C content in the present invention is controlled within 0.12-0.16%.

Mn: Mn is a low-cost element. Mn atoms can strengthen the solid solution by substituting the solid solution and causing lattice distortion. In the present invention, Mn is the primary element in obtaining high-strength steels with a tensile strength of 780-980 MPa. Taking into account the problem of C/Mn segregation caused by excessive Mn content, and problem that excessive Mn content in DH steel leads to increased hardenability so as to inhibit the formation of bainite, the addition of Mn should not exceed the range of the present invention. Considering the combined addition of Mn, Cr, Mo and Ni, the Mn content in the present invention is controlled within 1.80-2.30%.

Si: Si is one of the important elements in the present invention. A sufficient addition of Si ensures the strength of the ferrite matrix. Meanwhile, the addition of Si will raise the AC3 temperature of the steel plate, effectively adjusting the annealing process window during the continuous annealing stage, and ensuring the appropriate proportion of ferrite and austenite in the critical zone at the industrial continuous annealing temperature. In addition, the sufficient addition of Si can inhibit the formation of carbides during over-aging, preventing steel plates from experiencing reduced performance due to carbide precipitation. Taking into account a high Si content may lead to surface quality problems such as skip plating on galvanized surfaces and problem of increased difficulty in acid pickling (due to internal oxidation layers and grain boundary oxidation layers), the Si content in the present invention is kept within a moderate range for high-strength steels. The Si content should not be too low, otherwise, it will fail to inhibit the carbide precipitation, which is a critical requirement for the application of QP steel and DH steel. In the present invention, the Si content is controlled within 0.60-1.30%.

Al: Al is only used as a deoxidizer in the present invention. Since the present invention is intended to solve the problem of one steel for multipurpose, the addition of Al will significantly increase costs and complicate continuous sequence casting. In the present invention, the Al content is controlled within 0.015-0.5%.

P: P is an impurity element in steels, which is highly prone to segregate at grain boundaries. When the P content in steel is high, it tends to form Fe₂P particles, reducing the plasticity and toughness of steels. Therefore, the lower P content is better. In the present invention, the P content is controlled within 0.007-0.012%.

S: S is an impurity element in steels, and prone to combine with Mn to form MnS inclusions, deteriorating the plasticity of steel plates. Therefore, the lower S content is better. In the present invention, the S content is controlled within 0.001-0.004%.

Among optional elements:

Ni: Ni is a solid solution strengthening element. Like C and Mn, Ni can enhance the stability of austenite. Additionally, Ni can improve the corrosion resistance of steel plates to a certain extent. As an optional component, Ni can be added in appropriate amounts in the present invention to improve the corrosion resistance of steel plates. In the present invention, the Ni content is controlled within 0.10-0.30%.

Cr and Mo: Cr and Mo are solid solution strengthening elements, which serve to enhance the strength of steel plates. In the present invention, Cr and Mo can improve the hardenability of the steel plate, delay the formation of pearlite and bainite during the cooling stage, and promote the formation of martensite. Meanwhile, Cr and Mo can alter the type of iron oxide scale during the coiling process, restrict the internal oxidation of the steel plate, and improve the surface quality of the steel plate. In the present invention, Cr and Mo serve as supplementary elements to Mn to balance the problems of hot-rolled edge cracks and cold-rolled edge cracks. In the present invention, the Cr content is controlled within 0.10-0.50%, and the Mo content is controlled within 0.05-0.30%.

As previously mentioned, alloying elements of Ni, Cr, and Mo are all supplementary alternatives to Mn, which primary role in the present invention is to improve the stability of austenite to compensate for the stability of austenite. However, comprehensively considering multiple factors such as cost and difficulties of steel casting and hot rolling as well as cold rolling, their overall addition should meet the integrated objectives of low cost, easy production and high yield, that is, the total content of Mn, Ni, Cr and Mo is less than or equal to 2.6%.

Nb: Nb is a microalloy strengthening element. In the production of DP steel products and DH steel products, Nb as an optional element can be added in conjunction with Ti to refine grain sizes and improve the yield-to-tensile strength ratio, thereby enhancing the flanging performance of the steel plate in subsequent processing. In the present invention, the Nb content is controlled within 0.015-0.025%.

Ti: In the present invention, an appropriate amount of Ti is added as a supplement to enhance strength. In the steel for multi purposes, some planned components cannot meet the strength requirements, and the precipitation of Ti plays a role in refining prior austenite grains, as well as providing precipitation strengthening to supplement the strength. In the present invention, the Ti content is controlled within 0.015-0.025%.

Another aspect of the present invention is to provide a method for preparing the abovementioned multipurpose high-strength steel for automobiles, including steps of continuous casting, hot rolling, acid pickling, cold rolling, and continuous annealing and galvanizing. The steps of the method are as follows:
(1) Continuous casting: perform continuous casting according to the chemical components of the steel abovementioned, and obtain a billet;
(2) Hot rolling: heat a the billet, and then preform rough rolling, finishing rolling, and coiling on the billet to obtain a hot-rolled coil;
(3) Acid pickling and cold rolling: perform cold rolling on the hot-rolled coil after acid pickling to obtain a cold-rolled steel sheet; and
(4) Continuous annealing and galvanizing: heat the cold-rolled steel sheet to 820-950° C. and subject it to isothermal holding for 35-120 s, then slowly cool the steel sheet to 700-780° C. at a cooling rate of 1.2-3.6° C./s, followed by cooling the steel sheet to 380-470° C. at a rate of 15-25° C./s and subjecting it to isothermal holding for 15-25 s, and then make the cooled steel sheet enter a galvanizing pot and finally enter an alloying furnace for alloying at a temperature of 480-560° C. for 15-25 s.

In the above technical solution, further in step (1), a casting temperature is 1580-1620° C./s-3. a thickness of the billet is 220-280 mm.

In the above technical solution, further in step (2), a heating temperature is 1230-1280° C., a heating time in furnace is 180-240 min; a rough rolling temperature is 1150-1200° C., a thickness of an intermediate billet is 50-80 mm; the finish rolling comprises two stages of recrystallization rolling and final rolling, with a recrystallization rolling temperature of 1070-1130° C. and a final rolling temperature of above 920° C.; a coiling temperature is 450-520° C.; and a thickness of the hot-rolled coil is 2.8-3.5 mm.

The purpose of controlling the heating temperature at 1230-1280° C. and the heating time in furnace at 180-240 min is to promote full solid solution of the alloy and control the banded structure caused by segregation. The purpose of dividing the finish rolling into two stages is to promote the recrystallization behavior of the prior austenite grains and inhibit the coarsening of non-recrystallized austenite grains. The purpose of controlling the coiling temperature at 450-520° C. is to prevent the formation of Si-rich oxides on the surface of the steel plate due to the addition of Si, which could lead to the formation of internal oxidation layers and grain boundary oxidation layers.

In the above technical solution, further in step (3), a thickness of the cold-rolled steel sheet is 1.4/1.6/1.8 mm. The 1.4 mm cold-rolled steel sheet is produced from a 2.8 mm hot-rolled coil, and the 1.6 mm and 1.8 mm cold-rolled steel sheets are produced from a 3.0-3.5 mm hot-rolled coil. A reduction rate of the cold rolling is 46.7-48.6%.

An insufficient rolling reduction cannot ensure adequate cold rolling deformation energy storage, resulting in inadequate ferrite recrystallization during the continuous annealing stage. An excessively high rolling reduction significantly increases the load on the cold rolling mill, making it impossible to achieve a target thickness.

In the above technical solution, further in step (4), the continuous annealing and galvanizing process is as follows: heat the cold-rolled steel sheet to 820-850° C. and subject it to isothermal holding for 60-105 s, then slowly cool the steel sheet to 700-740° C. at a cooling rate of 1.2-3.6° C./s, followed by cooling the steel sheet to 380-460° C. at a rate of 15-25° C./s and subject it to isothermal holding for 15-25 s, and then make the cooled steel sheet enter the galvanizing pot and finally enter the alloying furnace for alloying at a temperature of 495-505° C. for 15-25 s. The steel products obtained by this process meet the requirements of the DH780 steel.

Through the method mentioned previously, intercritical isothermal treatment produces a high-proportion of ferrite structure in steels, and the concentration of C in the intercritical austenite increases as ferrite forms; after slow cooling, a pronounced C concentration gradient is formed within undercooled austenite; during the temperature range of 380-460° C., bainite formation is promoted and carbon continuous to enrich in the surrounding undercooled austenite along the concentration gradient; after alloying, C-enriched and fine-grained undercooled austenite is retained in steels to room temperature as retained austenite, and C-depleted and coarser-grained undercooled austenite undergoes martensitic transformation.

In the above technical solution, further in step (4), the continuous annealing and galvanizing process is as follows: heat the cold-rolled steel sheet to 860-900° C. and subject it to isothermal holding for 35-45 s, then slowly cool the steel sheet to 750-780° C. at a cooling rate of 1.2-3.6° C./s, followed by cooling the steel sheet to 380-460° C. at a rate of 15-25° C./s and subjecting it to isothermal holding for 15-25 s, and then make the cooled steel sheet enter the galvanizing pot and finally enter the alloying furnace for alloying at a temperature of 495-505° C. for 15-25 s. The steel products obtained by this process meet the requirements of the DH980 steel.

Through the method mentioned previously, a high-proportion of austenite structure is obtained by intercritical isothermal treatment, and the formation of excessive epitaxial ferrite is regulated and inhibited by slow cooling to ensure yield strength; during the temperature range of 380-460° C., bainite formation is promoted and carbon continuous to enrich in the surrounding undercooled austenite along the concentration gradient; after alloying, C-enriched and fine-grained undercooled austenite size is retained to room temperature as retained austenite, and C-depleted and coarser-grained undercooled austenite undergoes martensitic transformation; and the alloying temperature is controlled to prevent formation of excessive carbides that could affect the strength of the steel sheet.

In the above technical solution, further in step (4), the continuous annealing and galvanizing process is as follows: heat the cold-rolled steel sheet to 860-900° C. and subject it to isothermal holding for 100-120 s, then slowly cool the steel sheet to 750-780° C. at a cooling rate of 1.2-3.6° C./s, followed by cooling the steel sheet to 380-460° C. at a rate of 15-25° C./s and subject it to isothermal holding for 15-25 s, and then make the cooled steel sheet enter the galvanizing pot and finally enter the alloying furnace for alloying at a temperature of 530-560° C. for 15-25 s. The steel products obtained by this process meet the requirements of the DP980 steel.

Through the method mentioned previously, a high-proportion of austenite structure is obtained by intercritical isothermal treatment, a prolonged isothermal time promotes grain coarsening and homogenization of C concentration, and the formation of excessive epitaxial ferrite is regulated and inhibited by slow cooling to ensure yield strength; and the alloying temperature is controlled to promote the formation of secondary martensite.

In the above technical solution, further in step (4), the continuous annealing and galvanizing process is as follows: heat the cold-rolled steel sheet to 920-950° C. and subject it to isothermal holding for 60-100 s, then slowly cool the steel sheet to 750-780° C. at a cooling rate of 1.2-3.6° C./s, followed by cooling the steel sheet to 340-400° C. at a rate of 15-25° C./s, then raise the temperature to 450-470° C. and subject the steel sheet to isothermal holding for 15-25 s, then make the steel sheet enter the galvanizing pot and finally enter the alloying furnace for alloying at a temperature of 480-495° C. for 15-25 s. The steel products obtained by this process meet the requirements of the QP980 steel.

Through the method mentioned previously, a fully austenite structure is obtained by intercritical isothermal treatment, and the formation of excessive epitaxial ferrite is regulated and inhibited by slow cooling to ensure yield strength; during the temperature range of 380-460° C., martensite transformation is promoted while retaining a certain amount of retained austenite; by raising the temperature followed by isothermal holding, the martensite undergoes tempering to form tempered martensite, and C is enriched in retained austenite to enhance stability of the steel sheet; and during the alloying process, excessive temperature should be prevented to avoid carbide precipitation from tempered martensite.

The present invention has the following beneficial effects:

The present invention proposes using steel plates with identical or similar components to achieve coverage of multiple steel grades and strength levels through different heat treatment processes. On the production side, the method of the present invention reduces scrap steel generation during a mixed casting section, enhances the rolling production efficiency, and optimizes management processes; and on the application side, the method may decrease material welding difficulty and expand the material's application scope.

The application of the present invention can achieves energy conservation and emission reduction in the production and application processes, aligning with China's “dual carbon” policy goals.

### BRIEF DESCRIPTION OF THE DRAWINGS

The sole FIGURE shows the microstructure images of four steels produced from Compositon-1 according to the present invention, wherein panel (a) is a steel marked DH780-1, panel (b) is a steel marked DH980-1, panel (c) is a steel marked DP980-1, and panel (d) is a steel marked QP980-1.

### DETAILED DESCRIPTION OF THE EMBODIMENTS

The present invention is described in detail through the embodiments below, which are provided only to describe preferred implementations of the present invention and do not limit the scope of the present invention in any way.

The chemical components of the steels in embodiments are listed in Table 1.

TABLE 1
Chemical component of steels in embodiments, wt %

| Embodiment | C | Mn | Si | Al | Ni | Cr | Mo | Mn + Ni + Cr + Mo | Ti | Nb | P | S |
|---|---|---|---|---|---|---|---|---|---|---|---|---|
| Component-1 | 0.148 | 2.23 | 0.95 | 0.015 | — | — | — | 2.23 | 0.025 | — | 0.009 | 0.002 |
| Component-2 | 0.126 | 2.28 | 0.75 | 0.42 | 0.15 | — | 0.05 | 2.48 | 0.018 | 0.022 | 0.011 | 0.001 |
| Component-3 | 0.158 | 2.08 | 1.02 | 0.48 | 0.1 | 0.12 | 0.15 | 2.45 | 0.022 | — | 0.012 | 0.003 |
| Component-4 | 0.135 | 2.15 | 0.96 | 0.015 | 0.13 | 0.18 | — | 2.46 | 0.015 | 0.019 | 0.007 | 0.004 |
| Component-5 | 0.145 | 2.31 | 1.23 | 0.24 | — | 0.15 | — | 2.46 | 0.018 | 0.018 | 0.008 | 0.002 |

A method for preparing the multipurpose high-strength steel for automobiles includes the following steps:

(1) Continuous casting: continuous casting was performed using the chemical components of steels listed in table 1 and corresponding billets were obtained, with a casting temperature of 1580-1620° C. and a billet thickness of 220-280 mm.

(2) Hot rolling: the billets were heated at a heating temperature of 1230-1280° C. for 180-240 min in a furnace; then the heated billets were rough-rolled at a rough rolling temperature of 1150-1200° C., and intermediate billets with a thickness of 50-80 mm were obtained; the intermediate billets underwent a two-stage finishing rolling of recrystallization rolling at a temperature of 1070-1130° C. and final rolling at a temperature of above 920° C.; and the finishing-rolled billets were coiled at a temperature of 450-520° C., and hot-rolled coils with a thickness of 2.8-3.5 mm were obtained.

(3) Acid pickling and cold rolling: the hot-rolled coils were subject to cold rolling after acid pickling, and cold-rolled steel sheets were obtained with a thickness of 1.4/1.6/1.8 mm, of which the 1.4 mm cold-rolled steel sheet was produced from the 2.8 mm hot-rolled coil, the 1.6 mm and 1.8 mm cold-rolled steel sheets was produced from the 3.0-3.5 mm hot-rolled coil, and the reduction rate of the cold rolling was 46.7-48.6%.

(4) Continuous annealing and galvanizing: the cold-rolled steel sheets were heated to 820-850° C. and were subject to isothermal holding for 60-105 s, then the steel sheets were slowly cooled to 700-740° C. at a cooling rate of 1.2-3.6° C./s, followed by cooling the steel sheets to 380-460° C. at a rate of 15-25° C./s and subjecting it to isothermal holding for 15-25 s, and then made the cooled steel sheets enter a galvanizing pot and finally enter an alloying furnace for alloying at a temperature of 495-525° C. for 15-25 s. The steel products obtained by this process met the requirements of the DH780 steel.

The cold-rolled steel sheets were heated to 860-900° C. and were subject to isothermal holding for 35-45 s, then the steel sheets were slowly cooled to 750-780° C. at a cooling rate of 1.2-3.6° C./s, followed by cooling the steel sheets to 380-460° C. at a rate of 15-25° C./s and subjecting it to isothermal holding for 15-25 s, and then made the cooled steel sheets enter a galvanizing pot and finally enter an alloying furnace for alloying at a temperature of 495-505° C. for 15-25 s. The steel products obtained by this process met the requirements of the DH980 steel.

The cold-rolled steel sheets were heated to 860-900° C. and were subject to isothermal holding for 100-120 s, then the steel sheets were slowly cooled to 750-780° C. at a cooling rate of 1.2-3.6° C./s, followed by cooling the steel sheets to 380-460° C. at a rate of 15-25° C./s and subjecting it to isothermal holding for 15-25 s, and then made the cooled steel sheets enter a galvanizing pot and finally enter an alloying furnace for alloying at a temperature of 530-560° C. for 15-25 s. The steel products obtained by this process met the requirements of the DP980 steel.

The cold-rolled steel sheets were heated to 920-950° C. and were subject to isothermal holding for 60-100 s, then the steel sheets were slowly cooled to 750-780° C. at a cooling rate of 1.2-3.6° C./s, followed by cooling the steel sheets to 450-470° C. at a rate of 15-25° C./s and subjecting it to isothermal holding for 15-25 s, and then made the cooled steel sheets enter a galvanizing pot and finally enter an alloying furnace for alloying at a temperature of 480-495° C. for 15-25 s. The steel products obtained by this process met the requirements of the QP980 steel.

Following the aforementioned preparation method, Component-1 listed in Table 1 was used to produce steels marked DH780-1, DH980-1, DP980-1, QP980-1, with analogous procedures applied to other components listed in Table 1.

The process parameters of continuous casting and hot rolling for the embodiment steels are listed in Table 2, while the process parameters of cold rolling and continuous annealing and galvanizing for the embodiment steels are listed in Table 3.

TABLE 2
Process parameters of continuous casting and hot rolling for the embodiment steels

| | Casting | Billet | Heating | Rough rolling | Initial rolling | Final rolling | Coiling |
|---|---|---|---|---|---|---|---|
| | temperature/ | thickness/ | temperature/ | temperature/ | temperature/ | temperature/ | temperature/ |
| Embodiment | ° C. | mm | ° C. | ° C. | ° C. | ° C. | ° C. |
| DH780-1 | 1598 | 220 | 1235 | 1164 | 1098 | 925 | 488 |
| DH780-2 | 1592 | 250 | 1276 | 1185 | 1065 | 934 | 490 |
| DH780-3 | 1600 | 250 | 1277 | 1192 | 1097 | 933 | 453 |
| DH780-4 | 1612 | 240 | 1278 | 1158 | 1085 | 942 | 476 |
| DH780-5 | 1603 | 230 | 1277 | 1168 | 1072 | 942 | 468 |
| DH980-1 | 1583 | 230 | 1234 | 1157 | 1124 | 923 | 490 |
| DH980-2 | 1598 | 220 | 1245 | 1164 | 1128 | 935 | 453 |
| DH980-3 | 1594 | 250 | 1253 | 1153 | 1116 | 934 | 476 |
| DH980-4 | 1605 | 250 | 1268 | 1198 | 1112 | 956 | 468 |
| DH980-5 | 1602 | 240 | 1253 | 1174 | 1098 | 943 | 453 |
| DP980-I | 1582 | 220 | 1247 | 1176 | 1113 | 925 | 513 |
| DP980-2 | 1589 | 250 | 1232 | 1185 | 1124 | 921 | 508 |
| DP980-3 | 1597 | 250 | 1268 | 1191 | 1108 | 935 | 520 |
| DP980-4 | 1603 | 240 | 1255 | 1174 | 1105 | 944 | 512 |
| DP980-5 | 1598 | 240 | 1263 | 1155 | 1117 | 932 | 502 |
| QP980-1 | 1602 | 230 | 1257 | 1158 | 1089 | 942 | 476 |
| QP980-2 | 1603 | 230 | 1263 | 1162 | 1082 | 942 | 468 |
| QP980-3 | 1613 | 220 | 1254 | 1182 | 1074 | 926 | 482 |
| QP980-4 | 1618 | 220 | 1269 | 1163 | 1084 | 934 | 482 |
| QP980-5 | 1605 | 270 | 1254 | 1185 | 1096 | 933 | 478 |

TABLE 3
Process parameters of cold rolling and continuous annealing and galvanizing for the embodiment steels

| | Isothermal | | Slow cooling | Slow cooling | Fast cooling | Fast cooling | Overaging | | Alloying | |
|---|---|---|---|---|---|---|---|---|---|---|
| | temperature/ | Isothermal | rate/ | temperature/ | rate/ | temperature/ | temperature/ | Isothermal | temperature/ | Alloying |
| Embodiment | ° C. | time/s | ° C. | ° C. | ° C./s | ° C. | ° C. | time/s | ° C. | time/s |
| DH780-1 | 835 | 75 | 1.85 | 718 | 16 | 384 | 455 | 18 | 498 | 18 |
| DH780-2 | 842 | 65 | 2.84 | 725 | 18 | 452 | 460 | 25 | 521 | 18 |
| DH780-3 | 846 | 85 | 2.56 | 728 | 25 | 406 | 460 | 22 | 508 | 22 |
| DH780-4 | 828 | 95 | 2.35 | 705 | 22 | 426 | 450 | 21 | 495 | 25 |
| DH780-5 | 822 | 105 | 3.23 | 734 | 17 | 431 | 450 | 20 | 522 | 19 |
| DH980-1 | 865 | 36 | 1.94 | 756 | 16 | 396 | 450 | 17 | 498 | 17 |
| DH980-2 | 892 | 38 | 2.56 | 777 | 21 | 418 | 460 | 16 | 495 | 16 |
| DH980-3 | 878 | 35 | 2.16 | 761 | 22 | 406 | 470 | 18 | 502 | 18 |
| DH980-4 | 864 | 42 | 2.98 | 759 | 24 | 452 | 450 | 15 | 500 | 22 |
| DH980-5 | 895 | 43 | 3.02 | 772 | 20 | 446 | 455 | 13 | 503 | 19 |
| DP980-1 | 894 | 116 | 3.06 | 754 | 24 | 423 | 470 | 15 | 534 | 18 |
| DP980-2 | 882 | 108 | 2.68 | 768 | 21 | 444 | 460 | 16 | 552 | 22 |
| DP980-3 | 873 | 106 | 2.45 | 773 | 18 | 428 | 455 | 18 | 538 | 25 |
| DP980-4 | 868 | 112 | 1.86 | 758 | 22 | 415 | 465 | 22 | 542 | 19 |
| DP980-5 | 885 | 105 | 1.77 | 759 | 24 | 456 | 455 | 23 | 555 | 21 |
| QP980-1 | 924 | 64 | 1.56 | 765 | 18 | 385 | 470 | 18 | 487 | 18 |
| QP980-2 | 935 | 87 | 2.45 | 762 | 20 | 345 | 450 | 19 | 482 | 19 |
| QP980-3 | 945 | 75 | 2.28 | 777 | 21 | 395 | 455 | 18 | 492 | 18 |
| QP980-4 | 928 | 69 | 1.08 | 754 | 24 | 362 | 470 | 23 | 488 | 22 |
| QP980-5 | 935 | 92 | 2.36 | 780 | 22 | 357 | 465 | 16 | 485 | 23 |

Table 4 shows the mechanical properties of the embodiment steels.

TABLE 4
Mechanical properties of the embodiment steels

| Embodiment | F/% | M/% | TM/% | RA% | B/% | Rp0.2/MPa | Rm/MPa | A80/% | λ/% |
|---|---|---|---|---|---|---|---|---|---|
| DH780-1 | 58.6 | 20.3 | — | 6.5 | 6.8 | 454 | 834 | 24.6 | 56.3 |
| DH780-2 | 54.2 | 22.5 | — | 7.2 | 8.9 | 462 | 836 | 25.4 | 48.6 |
| DH780-3 | 53.8 | 21.4 | — | 58 | 8.4 | 458 | 846 | 23.8 | 49.2 |
| DH780-4 | 52.7 | 15.8 | — | 5.4 | 9.6 | 443 | 827 | 25.2 | 52.1 |
| DH780-5 | 58.2 | 18.6 | — | 6.3 | 9.2 | 459 | 852 | 25.1 | 53.4 |
| DH980-1 | 39.4 | 26.5 | — | 8.2 | 6.7 | 705 | 1035 | 18.7 | 31.6 |
| DH980-2 | 42.8 | 32.4 | — | 6.5 | 7.3 | 722 | 1046 | 19.2 | 34.5 |
| DH980-3 | 44.2 | 34.2 | — | 7.8 | 5.9 | 716 | 1028 | 18.4 | 32.5 |
| DH980-4 | 38.6 | 33.5 | — | 8.6 | 7.2 | 725 | 1034 | 20.1 | 33.7 |
| DH980-5 | 38.5 | 29.7 | — | 9.2 | 7.8 | 706 | 1029 | 19.8 | 32.1 |
| DP980-1 | 52.6 | 35.2 | — | — | — | 648 | 1062 | 16.5 | 24.5 |
| DP980-2 | 57.4 | 38.4 | — | — | — | 652 | 1053 | 17.2 | 22.8 |
| DP980-3 | 62.3 | 35.6 | — | — | — | 562 | 1048 | 168 | 21.6 |
| DP980-4 | 54.1 | 34.7 | — | — | — | 598 | 1058 | 17.2 | 22.5 |
| DP980-5 | 55.8 | 42.2 | — | — | — | 604 | 1066 | 16.3 | 25.6 |
| QP980-1 | 12.4 | — | 68.4 | 11.8 | 6.8 | 798 | 1012 | 14.2 | 68.5 |
| QP980-2 | 6.8 | — | 72.5 | 12.2 | 7.2 | 823 | 1036 | 14.8 | 72.4 |
| QP980-3 | 9.6 | — | 71.8 | 10.9 | 7.8 | 812 | 1042 | 14.1 | 66.4 |
| QP980-4 | 8.2 | — | 65.6 | 10.5 | 9.5 | 822 | 1018 | 15.8 | 68.2 |
| QP980-5 | 11.8 | — | 74.2 | 11.6 | 9.2 | 805 | 1026 | 15.2 | 67.4 |

It can be seen from Table 4 that the DH780 steel products have a microstructure consisting of ferrite, retained austenite, bainite and martensite, with a ferrite content of 50-60%, a martensite content of 10-25%, a bainite content of 5-10%, and a retained austenite content of 5-7.5%; and the yield strength of the DH780 steel products is above 440 MPa, the tensile strength is above 780 MPa, the elongation is above 23%, and the hole expansion rate is above 45%.

The DH980 steel products have a microstructure consisting of ferrite, retained austenite, bainite and martensite, with a ferrite content of 35-45%, a martensite content of 25-35%, a bainite content of 5-10%, and a residual austenite content of 5-7.5%; and the yield strength of the DH980 steel products is above 700 MPa, the tensile strength is above 980 MPa, the elongation is above 16%, and the hole expansion rate is above 30%.

The DP980 steel products have a microstructure consisting of ferrite and martensite, with a ferrite content of 45-65%, and a martensite content of 35-55%; and the yield strength of the DP980 steel products is above 550 MPa, the tensile strength is above 980 MPa, the elongation is above 16%, and the hole expansion rate is above 20%.

The QP980 steel products have a microstructure consisting of ferrite, retained austenite, bainite and tempered martensite, with a ferrite content of 5-15%, a tempered martensite content of 65-75%, a bainite content of 5-10%, and a retained austenite content of 10-12.5%; and the yield strength of the QP980 steel products is above 780 MPa, the tensile strength is above 980 MPa, the elongation is above 14%, and the hole expansion rate is above 65%.

The above embodiments are merely preferred embodiments of the present invention, and are not intended to limit the implementations. The protection scope of the present invention shall be subject to the scope defined by the claims. On the basis of the above description, other changes or variations in different forms can be also made. Obvious changes or variations derived therefrom remain within the protection scope of the present invention.

1. A multipurpose high-strength steel for automobiles, comprising the following chemical components in percentage by mass:
0.12-0.16% of C, 1.80-2.30% of Mn, 0.60-1.30% of Si, 0.015-0.5% of Al, 0.007-0.012% of P, 0.001-0.004% of S, and a balance of Fe and inevitable impurities.

2. The multipurpose high-strength steel for automobiles according to claim 1, wherein the chemical components of the steel further comprises at least one of Ni, Cr, Mo, Nb and Ti, with their contents in percentage by mass: 0.10-0.30% of Ni, 0.10-0.30% of Cr, 0.0.5-0.30% of Mo, 0.015-0.025% of Nb, and 0.01-0.025% of Ti, wherein a total mass of Mn, Ni, Cr and Mo is less than or equal to 2.50%.

3. A method for preparing the multipurpose high-strength steel for automobiles according to claim 1, comprising steps of continuous casting, hot rolling, acid pickling, cold rolling, and continuous annealing and galvanizing;
the steps are as follows:
(1) continuous casting: performing continuous casting according to the chemical components of the steel, and obtaining a billet;
(2) hot rolling: heating the billet, and then preforming rough rolling, finishing rolling, and coiling on the billet to obtain a hot-rolled coil;
(3) acid pickling and cold rolling: performing cold rolling on the hot-rolled coil after acid pickling to obtain a cold-rolled steel sheet; and
(4) continuous annealing and galvanizing: heating the cold-rolled steel sheet to 820-950° C. and subjecting it to isothermal holding for 35-120 s, then slowly cooling the steel sheet to 700-780° C. at a cooling rate of 1.2-3.6° C./s, followed by cooling the steel sheet to 380-470° C. at a rate of 15-25° C./s and subjecting it to isothermal holding for 15-25 s, and then making the cooled steel sheet enter a galvanizing pot and finally enter an alloying furnace for alloying at a temperature of 480-560° C. for 15-25 s.

4. The method according to claim 3, wherein in step (1), a casting temperature is 1580-1620° C., and a thickness of the billet is 220-280 mm.

5. The method according to claim 3, wherein in step (2), a heating temperature is 1230-1280° C., a heating time is 180-240 min, a rough rolling temperature is 1150-1200° C., a thickness of an intermediate billet is 50-80 mm, the finishing rolling comprises two stages of recrystallization rolling and final rolling, with a recrystallization rolling temperature of 1070-1130° C. and a final rolling temperature of above 920° C., a coiling temperature is 450-520° C., and a thickness of the hot-rolled coil is 2.8-3.5 mm.

6. The method according to claim 3, wherein in step (3), a thickness of the cold-rolled steel sheet is 1.4/1.6/1.8 mm, wherein the 1.4 mm cold-rolled steel sheet is produced from a 2.8 mm hot-rolled coil, the 1.6 mm and 1.8 mm cold-rolled steel sheets are produced from a 3.0-3.5 mm hot-rolled coil, and a reduction rate of the cold rolling is 46.7-48.6%.

7. The method according to claim 3, wherein in step (4), the continuous annealing and galvanizing process is as follows: heating the cold-rolled steel sheet to 820-850° C. and subjecting it to isothermal holding for 60-105 s, then slowly cooling the steel sheet to 700-740° C. at a cooling rate of 1.2-3.6° C./s, followed by cooling the steel sheet to 380-460° C. at a rate of 15-25° C./s and subjecting it to isothermal holding for 15-25 s, and then making the cooled steel sheet enter the galvanizing pot and finally enter the alloying furnace for alloying at a temperature of 495-525° C. for 15-25 s.

8. The method according to claim 3, wherein in step (4), the continuous annealing and galvanizing process is as follows: heating the cold-rolled steel sheet to 860-900° C. and subjecting it to isothermal holding for 35-45 s, then slowly cooling the steel sheet to 750-780° C. at a cooling rate of 1.2-3.6° C./s, followed by cooling the steel sheet to 380-460° C. at a rate of 15-25° C./s and subjecting it to isothermal holding for 15-25 s, and then making the cooled steel sheet enter the galvanizing pot and finally enter the alloying furnace for alloying at a temperature of 495-505° C. for 15-25 s.

9. The method according to claim 3, wherein in step (4), the continuous annealing and galvanizing process is as follows: heating the cold-rolled steel sheet to 860-900° C. and subjecting it to isothermal holding for 100-120 s, then slowly cooling the steel sheet to 750-780° C. at a cooling rate of 1.2-3.6° C./s, followed by cooling the steel sheet to 380-460° C. at a rate of 15-25° C./s and subjecting it to isothermal holding for 15-25 s, and then making the cooled steel sheet enter the galvanizing pot and finally enter the alloying furnace for alloying at a temperature of 530-560° C. for 15-25 s.

10. The method according to claim 3, wherein in step (4), the continuous annealing and galvanizing process is as follows: heating the cold-rolled steel sheet to 920-950° C. and subjecting it to isothermal holding for 60-100 s, then slowly cooling the steel sheet to 750-780° C. at a cooling rate of 1.2-3.6° C./s, followed by cooling the steel sheet to 340-400° C. at a rate of 15-25° C./s, then raising the temperature to 450-470° C. and subjecting the steel sheet to isothermal holding for 15-25 s, then making the steel sheet enter the galvanizing pot and finally enter the alloying furnace for alloying at a temperature of 480-495° C. for 15-25 s
